(19) United States
(12) Patent Application Publication
(10) Pub. No.: US 2026/0163866 A1
(43) Pub. Date: Jun. 11, 2026

(54) PROVIDING GROUP SECURITY POLICIES TO INGRESS DATA TRAFFIC FOR SPECIFIC DATA CENTER DESTINATIONS

(71) Applicant: Cisco Technology, Inc., San Jose, CA (US)

(72) Inventors: Prakash C. Jain, Fremont, CA (US); Senthil Murugan, Bangalore, Karnataka (IN); Sanjay Kumar Hooda, Pleasanton, CA (US); Mahesh Nagireddy, Milpitas, CA (US)

(21) Appl. No.: 18/975,194

(22) Filed: Dec. 10, 2024

(51) Int. Cl. H04L 9/40

(52) U.S. Cl. CPC H04L 63/029; H04L 63/0218

(57) ABSTRACT

Techniques for providing group tag security policies to ingress data traffic for specific Data Center destinations are described. The techniques may include receiving, at a fabric edge device and from a host device, an ingress data packet with the host device as a source and a destination of a data center device. The fabric edge device may transmit a request for a security group associated with the data center device to a host tracking database (DB). In response to receiving the security group associated with the data center device, the fabric edge device may apply a security policy associated with the security group to the ingress data packet.

### TECHNICAL FIELD

The present disclosure relates generally to providing destination security groups at ingress for each data center routing prefix installed in forwarding information base (FIB).

### BACKGROUND

In an enterprise network today, security group assignments are typically per host or per host subnets or pool privilege basis. However, at a data center (data center) the security group assignment is for servers or clusters security which is independent of the enterprise network and hosts group assignments. The prefixes are advertised between the data center and the enterprise network by a routing protocol like border gateway protocol (BGP) in the form of summarized or aggregated routes/prefixes. The way routing protocol summarizes or aggregates the prefixes is different and independent of the granularity of the prefixes to security group assignments provided by a security infrastructure such as an authentication, authorization, and accounting (AAA) server.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example environment that may implement various aspects of the technologies directed to ingress policy enforcement for data center routes/prefixes.

FIG. 2 illustrates an example environment that may implement various aspects of the technologies directed to providing destination security groups at ingress for each data center routing prefix installed in forwarding information base (FIB).

FIG. 3 illustrates an example diagram for steps taken for ingress policy enforcement for data center routes/prefixes.

FIG. 4 is a flow diagram illustrating an example method associated with the techniques described herein for to providing destination security groups at ingress for each data center routing prefix installed in forwarding information base (FIB).

FIG. 5 illustrates a block diagram illustrating an example packet switching system that can be utilized to implement various aspects of the technologies disclosed herein.

FIG. 6 illustrates a block diagram illustrating certain components of an example node that can be utilized to implement various aspects of the technologies disclosed herein.

FIG. 7 is a computer architecture diagram showing an illustrative computer hardware architecture for implementing a server device that can be utilized to implement aspects of the various technologies presented herein.

### DESCRIPTION OF EXAMPLE EMBODIMENTS

### Overview

This disclosure describes a method, for providing destination security groups at ingress for each data center routing prefix installed in forwarding information base (FIB). The method includes receiving, at a fabric edge device and from a host device, an ingress data packet with the host device as a source and a destination of a data center (data center) device. The method also includes transmitting, by the fabric edge device and to a host tracking database (DB), a request for a security group associated with the data center device. Also, the method includes, in response to receiving the security group associated with the data center device, applying, by the fabric edge device a security policy associated with the security group to the ingress data packet.

Additionally, the techniques described herein may be performed by a system and/or device having non-transitory computer-readable media storing computer-executable instructions that, when executed by one or more processors, performs the method described above.

### Example Embodiments

As described above, In an enterprise network today, security group assignments are typically per host or per host subnets or pool privilege basis. However, at a data center (data center) the security group assignment is for servers or clusters security which is independent of the enterprise network and hosts group assignments. The prefixes are advertised between the data center and the enterprise network by a routing protocol like border gateway protocol (BGP) in the form of summarized or aggregated routes/prefixes. The way routing protocol summarizes or aggregates the prefixes is different and independent of the granularity of the prefixes to security group assignments provided by an identity, security, policy engine (e.g., authentication, authorization, and accounting (AAA) server). For example, a security engine does not know how the data center advertises routing prefixes and its granularity of prefixes to security group assignment is different than the data center routing prefixes. In essence, conventionally the prefixes learned over the routing protocol layer are different than what is learned at the internet protocol (IP)-security group binding layer from the data center or any other external source.

This mismatch creates a problem in enterprise networks because the destination's security group cannot be known at ingress, thus a service insertion policy cannot be applied at ingress. Packets get forwarded according to a longest prefix match using the routes advertised by routing protocols, but policies need to be applied based on assigned security groups. For data center (data center) destinations /32 extract/variable prefixes and security groups cannot be downloaded or installed in a forwarding information base (FIB) due to scaling reasons. Thus, forwarding has to rely on less specific routes and a longest prefix match (often default 0/0 route). When individual /32 or a variable prefixes destination's security group is not present, and route prefixes installed in FIB do not match with the specific prefix to a security group assigned by a security infrastructure (e.g., AAA, or identity services engine (ISE), etc.) a security policy cannot be applied at ingress.

This disclosure describes an on-demand external control plane-based mechanism to provide destination security groups at ingress for each data center routing prefix (less specific and more specific) installed in FIB and forwarding tables. These techniques provide for optimized and scalable solutions to apply security group-based policy at the ingress and solves the data center, software defined network (SDN) and the secure access service edge (SASE) problem. Security groups and policies for data center services are applied by learning and associating data center prefixes with security groups on an AAA server. A security tags exchange protocol (e.g., SXP session) between the AAA server and service border allows internet protocol (IP) prefix-to-security group bindings. The service border integrates these bindings into an overlay protocol (e.g., border gateway protocol (BGP), ethernet virtual private network (EVPN), or locator/ID separation protocol (LISP), etc.) and registers with an external service control plane. Security group mappings are maintained in the FIB for policy enforcement, enabling secure packet forwarding to the data center after ingress policy application.

Techniques described herein allow for applying security groups and ingressing policy-based firewall/service insertion in enterprise networks for data center services. A security infrastructure, such as an AAA server or ISE learn data center prefixes (host and subnet) from various sources, such as a network controller, applications, data center policy engine, etc. The AAA server (or other security infrastructure) associates security groups with the learned data center prefixes. The AAA creates a security tags exchange protocol (e.g., SXP) session with the enterprise service border (overlay tunnel endpoint) connected to firewall security services. The AAA server transmits IP prefixes to security group binding to the service border via the security tags exchange protocol and filters the data center prefixes into security group bindings, either as host or subnet bindings.

A network controller configures the service border to learn specific data center subnet/prefix bindings from the security infrastructure via an overlay protocol (e.g., BGP, EVPN, LISP, etc.). Additionally, the network controller registers these data center subnet/prefix bindings with an external centralized service control plane (e.g., route reflector or map server). The service control plane stores the bindings as endpoint-to-tunnel endpoint mappings in the service control plane's route or mapping database even if there is no actual host detection or registration for these IP addresses. The service border also learns data center routes (host/subnet) via BGP (or other overlay protocol) and imports them into the overlay protocols database as learned host/prefixes.

The service border queries the security infrastructure to find the security group for the imported prefixes and registers the imported BGP route prefixes to the service control plane. If the security infrastructure has security groups associated with those prefixes, the service border registers those prefixes with the security group given by the security infrastructure. However, if the security infrastructure does not have a preexisting security group for an imported prefix, the security infrastructure returns that prefix with a ‘reserved unassigned data center security group’ and the service border registers that to the service control plane.

When a host device is detected at a fabric edge, the security infrastructure at the fabric edge requests a policy for the security group of the incoming host from the AAA server. The AAA server either provide the fabric edge with the AAA assigned security group, or provides ‘data center unassigned security group’ for the host's source security group if the security infrastructure does not have a preexisting assigned security group. When a packet arrives at the fabric edge from the host device that is destined for the data center, the fabric edge transmits a requests to the service control plane for the data center destination. The service control plane does a longest prefix search and replies with either the AAA assigned security group or ‘reserved unassigned data center security group’ and the service border as the destination device (e.g., switch or router) that is an egress tunnel endpoint. The fabric edge device that is the ingress switch or tunnel endpoint, populates the assigned or unassigned data center security group to the remote destination prefix mapping in the security infrastructure (with the source being the overlay protocol) and programs the mappings into FIB and forwarding tables. Forwarding keeps this security group mapping in its tree under known forwarding routes. Thus, each forwarding prefix (host or subnet) will have a security group associated and forwarding can use them to apply security group-based policies at the ingress edge switch.

After applying the policy at ingress, the data packet is correctly encapsulated to be redirected to the service border to apply firewall as per policy. Then the packet is finally forwarded to the data center if the firewall allows. Note, the assumption for the security appliance (e.g., firewall) is that it should be reachable from the service border/tunnel endpoint. Once packets are decapsulated at the service border or tunnel endpoint, they are routed to the security appliance since the security appliance is reachable from the service border. An encapsulation header on the packet would carry the additional information to indicate to the service border whether the packet needs to be forwarded to the security appliance, when coming from the fabric edge, and when the packet needs to be forwarded to a final destination, when coming back for the security appliance. Thus, ingress switches are able to apply group tag-based policy for all specific data center destinations even if forwarding/routing paths only have less specific prefixes/routes.

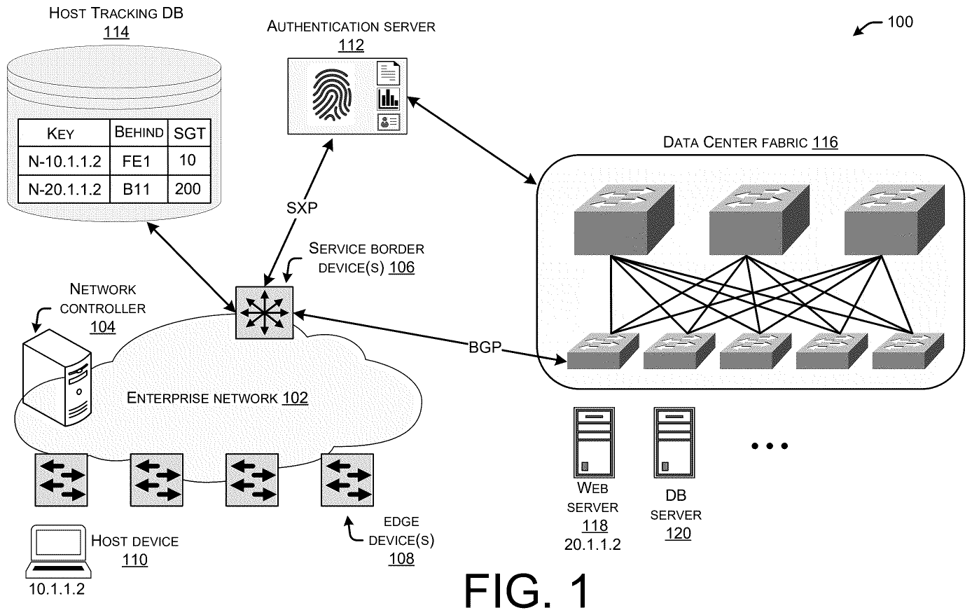

FIG. 1 illustrates an example environment 100 that may implement various aspects of the technologies directed to providing destination security groups at ingress for each data center routing prefix. Environment 100 includes an enterprise network 102. Enterprise network 102 may be a wired network or a wireless network. Enterprise network 102 may be a software defined wide area network (SDWAN) that includes multiple devices linked together for facilitating data communication. As an SDWAN, enterprise network 102 includes a network controller 104. Network controller 104 may provide centralized management of the enterprise network 102 and orchestrate or facilitate the functioning of enterprise network 102. Enterprise network 102 may be a network fabric that includes multiple different network devices such as service border device 106, edge device(s) 108, as well as other switches, bridges, routers, firewalls, repeaters, gateways, hubs, and the like. Enterprise network 102 is an example network, and any particular network may include more of less network devices of various kinds.

Environment 100 also include at least one host device 110. The host device 110 may access the enterprise network 102 via an edge device 108. In environment 100, the host device 110 in shown as a laptop connected to the enterprise network 102 via edge device 108. However, a host device 110 may be any user device that has access to enterprise network 102 (e.g., laptop, desktop computer, smart phone, tablet, etc.). Environment 100 also include an authentication server 112. The authentication server may be an AAA such as a RADIUS or any other appropriate type or authentication server (e.g., identity service engine (ISE), etc.). Environment 100 also includes a host tracking DB 114. The host tracking DB 114 is at the service control plane and may be a route reflector or map server such as map server map resolver (MSMR) or any other appropriate database of the service control plane. The host tracking DB 114 stores specific data center subnet/prefixes to security group bindings. Finally, environment 100 includes a data center with a data center fabric 116 with various devices connected, such as web server 118 and DB server 120.

To implement techniques described here for providing destination security groups at ingress for specific data center routing prefixes, the authentication server 112 learns data center (servers/clusters) prefixes (host as well as subnets) from various sources such as a network controller, applications, a data center policy engine, etc. The authentication server 112 then associates the data center prefixes with security groups. The authentication server 112 initiates a security tags exchange protocol (e.g., SXP) session with the service border device 106 (the overlay tunnel endpoint), connected to firewall security services. A security infrastructure at the service border receives internet protocol (IP) prefix to security group bindings from the authentication server 112 via SXP and filters data center prefixes into security group bindings (as host or subnet bindings).

The network controller 104 configures the service border device(s) 106 to learn specific data center subnet/prefixes to security group bindings from the security infrastructure via an overlay protocol (e.g., BGP, EVPN, LISP, etc.). These bindings are then registered with the external service control plane as shown in the host tracking DB 114. The service control plane stores these bindings as endpoint-to-tunnel endpoint mappings in the host tracking DB 114 (route/mapping DB) even if there is no actual host detection/registration for these IP addresses. Additionally, the service border device 106 learns data center routes (host and subnets) from BGP (as shown) and imports them into the host tracking DB 114 as learned hosts/prefixes. When the service border device(s) 106 registers the imported BGP routes prefixes to the service control plane host tracking DB 114, the service border device 106 first queries the security infrastructure to find the security group for the imported prefixes. If the security infrastructure doe does not have preexisting associated security groups for these imported prefixes, the security infrastructure returns a prefix with a ‘reserved unassigned data center security group’ and the service border device 106 registers that to the service control plane host tracking DB 114.

When the host device 110 is detected by an edge device 108, the security infrastructure at the access/edge transmits a request to the authentication server 112 for the policies for the security group of the incoming host device 110. The authentication server 112 provides either the policy for the assigned security group or the ‘data center unassigned security group’ for the host's source security group. When a packet transmitted by the host device 110 and destined for a data center device (e.g., web server 118) arrives at an edge device 108, the edge device 108 queries the service control plane for the data center destination. The service control plane performs the longest prefix match in the host tracking DB 114, and replies with either the assigned security group, or ‘reserved unassigned data center security group’ and the service border device 106 as the destination switch/router (egress tunnel endpoint). For example, if host device 110 sends a packet with a destination of web server 118, when the packet arrives at the edge device 108, the ingress edge device queries the host tracking DB 114 for an assigned policy. The service control plane finds the associate security policy in the host tracking DB 114, which in example environment 100 is security group 200 for destination web server 118. If there is no specific associate policy in host tracking DB 114, the indication will be that of ‘reserved unassigned data center security group’ and the indication that the service border device 106 is the egress tunnel endpoint switch/router.

Edge device 108 (the ingress switch or tunnel endpoint) populates the assigned/unassigned data center security group to remote destination prefix mapping in the security infrastructure (with source being the overlay protocol) and programs the information into FIB and forwarding tables. Security group mappings are maintained in the forwarding tree for known routes and security group-based policies are applied at the ingress edge switches such as edge device 108. Once a policy is applied to the packet at the edge device 108, the packet is correctly encapsulated to be redirected to the service border device 106 to apply firewall as per policy. The packet is decapsulated at the service border device 106 and routed to the firewall (per policy). If the packet is routed to the firewall, when it returns to the service border device 106 the service border device 106 routes the packet to its data center device final destination (e.g., web server 118). Thus, ingress switches are able to apply group tag-based policy for all specific data center destinations even if forwarding/routing paths only have less specific prefixes/routes.

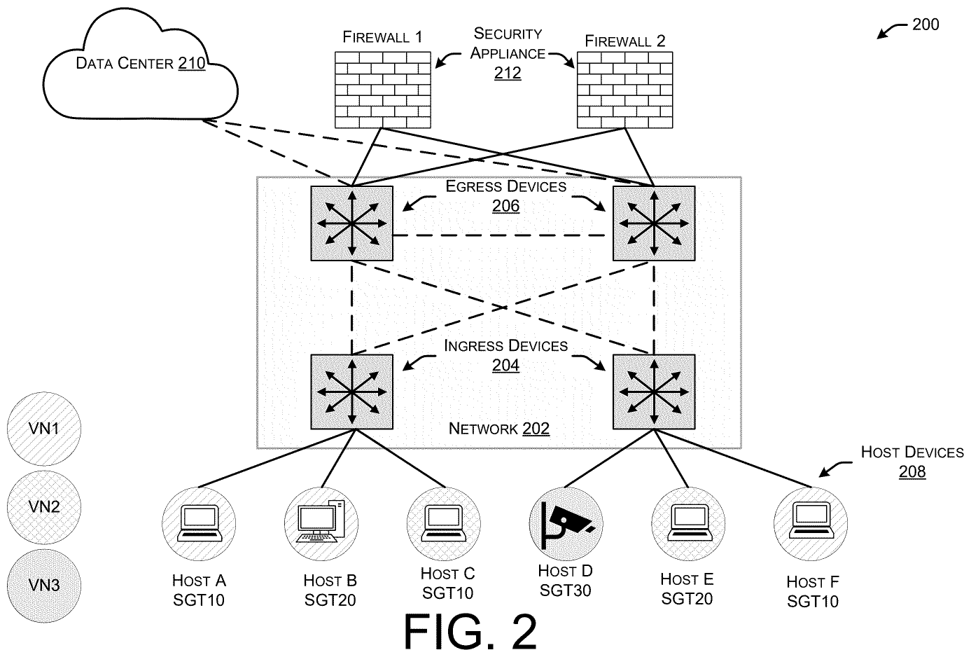

FIG. 2 illustrates an example environment 200 that may implement various aspects of the technologies directed to providing destination security groups at ingress instead of egress as conventional techniques provide for. Example environment 200 includes a network 202. Network 202 may be an SDWAN network similar to network 102 described with reference to FIG. 1 above. Network 202 may include any number and type of network devices such as the ingress devices 204 and egress device 206 as shown. Environment 200 also includes various host devices 208 connected to network 202 via the ingress devices 204. Host device 208 may be similar to host device 110 described above with reference to FIG. 1 and may be any type of user device that connects to a network such as a laptop, desktop computer, smartphone, etc., or even an internet of things (IoT) device as illustrated by Host D in example environment 200. Each host device 208 in example environment 200 is connected to on of virtual networks VN1, VN2, or VN3, and each host device 208 is associated with a security group as depicted by the security group tags SGT10, SGT20, and SGT30 associated with the various host devices 208. Example environment 200 also includes data center 210 connected to the network 202 via the egress devices 206. Data center 210 may be similar to data center 116 described above with reference to FIG. 1. Finally, example environment 200 includes security appliance(s) 212, which in example environment 200 are firewall 1 and firewall 2.

Consider an example security policy that indicates whether data traffic sent from a host device 208 and destined for a device at the data center 210 (example a web server such as web server 118 described above with reference to FIG. 1) should be routed straight to the device at the data center 210, should be routed through a security appliance 212 (e.g., firewall 1 or firewall 2), or should be dropped immediately. Using conventional techniques, the packet sent from a host device 208 with a data center 210 destination would enter network 202, travel through the network 202 (through various network devices) and once the packet reached an egress device 206 the appropriate policy could be applied (i.e., go straight to data center 210, go through security appliance 212, or drop the packet). However, using techniques described herein (see detailed description with reference to FIG. 1 above) when a packet sent from a host device 208 to a device at the data center 210 reaches an ingress device 204, the ingress device 204 can apply the appropriate security policy at packet ingress. Thus, appropriate security policies can be applied to data packets at ingress instead of egress.

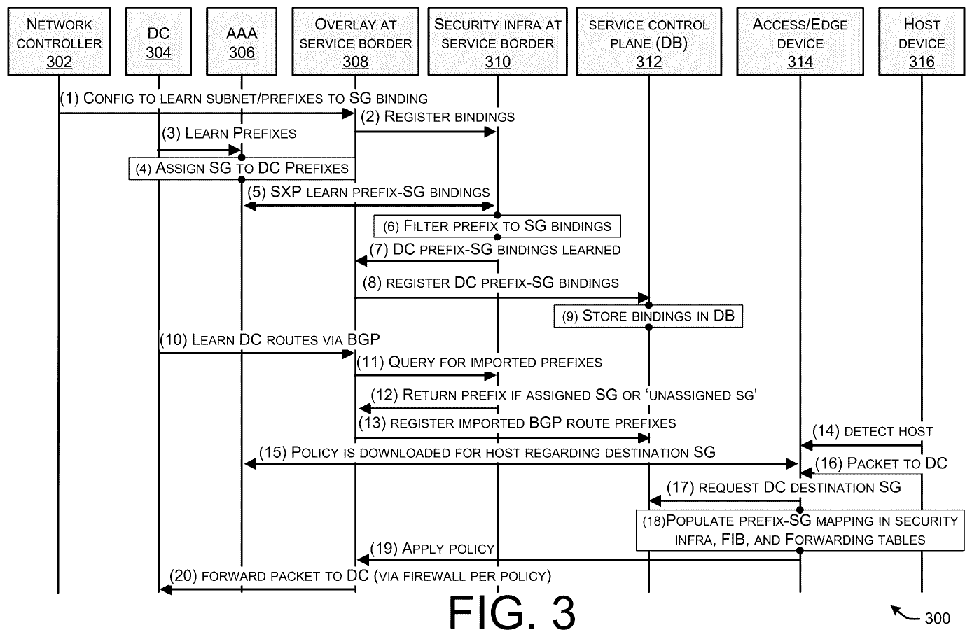

FIG. 3 illustrates example diagram 300 for steps taken for ingress policy enforcement for data center routes/prefixes. Example diagram 300 includes a network controller 302. The network controller 302 may be similar to network controller 104 as described with reference to FIG. 1 above. Network controller 302 may provide centralized management of a network and orchestrate or facilitate the functioning of the network. Example diagram 300 also includes a data center 304, such as data center 116 described with reference to FIG. 1. Example diagram 300 also includes an authentication server AAA 306. Although the authentication server illustrated in example diagram 300 is an AAA server, the techniques described herein may be implemented with any appropriate authentication server. Example diagram 300 also includes a service border (overlay at service border 308 and security infrastructure at service border 310) that may be analogous to functions performed by service border device 106 described in detail with reference to FIG. 1 above. Example diagram 300 diagram also include a service control plane 312 that includes an external centralized host tracking DB, which may be analogous to host tracking DB 114 described with reference to FIG. 1. Example diagram 300 also includes an access/edge device 314. The access/edge device 314 may be similar to the edge device(s) 108 described with reference to FIG. 1. Finally, example diagram 300 include a host device 316. Host device 316 may be similar to host device 110 described with reference to FIG. 1 or host devices 208 described with reference to FIG. 2.

To implement techniques described herein for ingress policy enforcement for data center routes/prefixes, at (1) network controller 302 configures the overlay service border 308 to learn subnet prefixes to security group bindings from the security infrastructure at service border 310. For example, with reference to FIG. 1 the network controller 104 can configure the service border device 106 to learn subnet prefixes to security group bindings for data center devices such as web server 118 of DB server 120. At (2) the overlay at service border 308 registers with the security infrastructure at service border 310 to learn specific data center subnet bindings as well as more specific bindings (prefixes to security group assignment). At (3) the authentication server AAA 306 learns data center (server/cluster) prefixes (host as well as subnet) from various sources such as network controller, applications, data center policy engine, etc., and at (4) assigns the data center prefixes to the associated security groups.

At (5) the security infrastructure at service border 310 receives IP prefix to security group bindings from the AAA 306 via security exchange protocol (e.g., SXP) and at (6) the security infrastructure at service border 310 filters the prefix to security group bindings (as host or subnet bindings). For example, with reference to FIG. 1 the service border device 106 receives IP prefix to security group bindings from the authentication server 112 via the SXP session shown. At (7) the overlay at service border 308 has learned the data center prefixes to security group bindings from the security infrastructure at service border 310 and at (8) the overlay at service border 308 registers the data center prefixes to security group bindings to the external centralized service control plane 312 and at (9) the bindings are stored as endpoint-to-endpoint mappings in its route/mapping DB even if there is no actual host detection/registration for these IP addresses. For example, with reference to FIG. 1, the data center prefixes to security group bindings are stored in the host tracking DB 114.

At (10) the overlay at service border 308 learns data center routes (host/subnet) via BGP. For example, with reference to FIG. 1, the service border device 106 imports the data center routes via BGP from the data center fabric 116 as shown. At (11) the overlay at service border 308 queries the security infrastructure at service border 310 for the security groups associated with the imported prefixes. At (12) if the security infrastructure has security groups associated with the imported prefixes, the security infrastructure at service border 310 returns the assigned security group, if the security infrastructure does not have associated security groups for these imported prefixes, the security infrastructure returns the prefix with a ‘reserved unassigned data center security group’ and at (13) the service border registers the imported BGP route prefixes (either the AA assigned security group or ‘unassigned data center security group’) to the service control plane 312.

At (14) the access/edge device 314 detects a host device 316 connected to the network fabric. For example, with reference to FIG. 1, when host device 110 connected to enterprise network 102, the connection is detected by an edge device 108 that the host device 110 is connecting to. At (15) the access/edge 314 requests the policy for the AAA 306 assigned security group of the incoming host device 316. The AAA 306 provides the policy for AAA assigned security groups if there is an assigned security group, if there is not a AAA assigned security group the AAA 306 provides ‘data center unassigned security group’ for the host's source security group.

At (16) the host device 316 send a data packet to the access/edge 314 with a destination at the data center. For example, with reference to FIG. 1 host device 110 sends a data packet to edge device 108 with a destination of data center device web server 118. At (17) when the packet arrives at access/edge 314, the access/edge 314 requests the data center destination security group from the service control plane 312. The service control plane 312 performs the longest prefix search and replies with either the AAA assigned security group (more specific than data center subnet) or ‘reserved unassigned data center security group AND the service border as the destination switch/router (egress tunnel endpoint). For example, with reference to FIG. 1, when the data packet sent by host device 110 arrives at the edge device 108, the edge device 108 queries the host tracking DB 114 for the web server 118 (data center destination) security group, which in example environment 100 is SGT 200.

At (18) the access/edge 314 populate the assigned and reserved unassigned data center security groups to remote destination prefix mapping in the security infrastructure (with source overlay protocol), FIB and forwarding tables. Forwarding keeps this security group mapping in its tree under known forwarding routes. This way each forwarding prefix (host or subnet) will have a security group associated and forwarding can use them to apply security group-based policies at the ingress edge switch. Thus, at (19) when the data packet sent from the host device 316 arrives at the access/edge 314 the appropriate policy is applied at ingress where at the packet is then correctly encapsulated to be redirected to overlay at service border 308 to apply firewall as per policy. At (20) the packet is finally forwarded to the data center if the firewall allows.

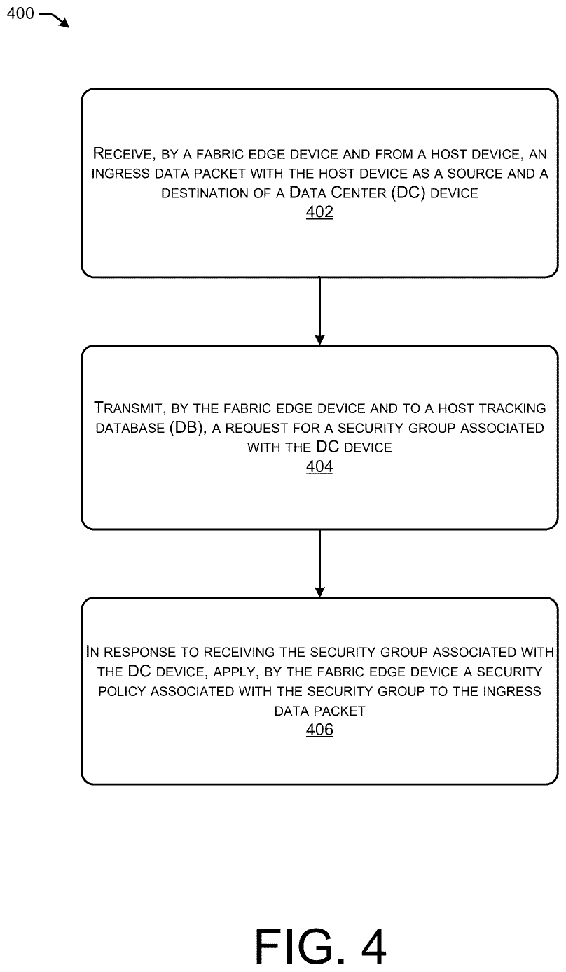

FIG. 4 is a flow diagram illustrating an example method associated with the techniques described herein for detecting IoT endpoint device reachability via inline monitoring with in-band probes in an SD-WAN overlay fabric. Example method 400 illustrates aspects of the functions performed by a fabric edge device 108 described with reference to FIG. 1 and ingress devices 204 described with reference to FIG. 2. The logical operations described herein with respect to FIG. 4 may be implemented (1) as a sequence of computer-implemented acts or program modules running on a computing system and/or (2) as interconnected machine logic circuits or circuit modules within the computing system. In some examples, the method(s) 400 may be performed by a system comprising one or more processors and one or more non-transitory computer-readable media storing computer-executable instructions that, when executed by the one or more processors, cause the one or more processors to perform the method(s) 400.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIG. 4 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

At operation 402, a fabric edge device receives an ingress data packet from a host device. The data packet source is the host, and the destination is a data center device. For example, with reference to FIG. 1 edge device 108 receives an ingress data packet from host device 110. The data packet includes information indicating that the source is host device 110 and the destination is a data center device, for example web server 118 or DB server 120. With reference to FIG. 2, an ingress device 204 receives a data packet from a host device 208. The data packet source is the host device 208 and the destination is a device at the data center 210.

At operation 404, the fabric edge device transmits a request for a security group associated with the data center device to a host tracking database (DB). For example, with reference to FIG. 1 the edge device 108 transmits a request for a security group associated with the data center device (e.g., web server 118) to the host tracking DB 114. The service control plane does a longest prefix search in the host tracking DB 114 and replies with either an assigned security group (assigned by the authentication server) or, in the case that there is not an assigned security group, the service control plane replies with ‘reserved unassigned data center security group’ and the service border device 106 as the destination switch/router (i.e., egress tunnel endpoint).

At operation 406, in response to receiving the security group associated with the data center device, the fabric edge device applies a security policy associated with the security group to the ingress data packet. For example, with reference to FIG. 1 when a data packet arrives at an edge device 108 from host device 110, the edge device 108 applies the policy as assigned by the authentication server 112 to the data packet. In addition, the edge device 108 populates the assigned (and unassigned) data center security group to remote destination prefix mapping in the security infrastructure which in turn programs that into FIB and forwarding tables. Security group mappings are maintained in the forwarding tress for known routes and security group policies are applied at the ingress edge switch (e.g., edge device(s) 108). After the policy is applied at ingress, the packet is encapsulated to be redirected to the service border to apply firewall as per policy, after which, the packet is finally forwarded to the data center device if the firewall allows.

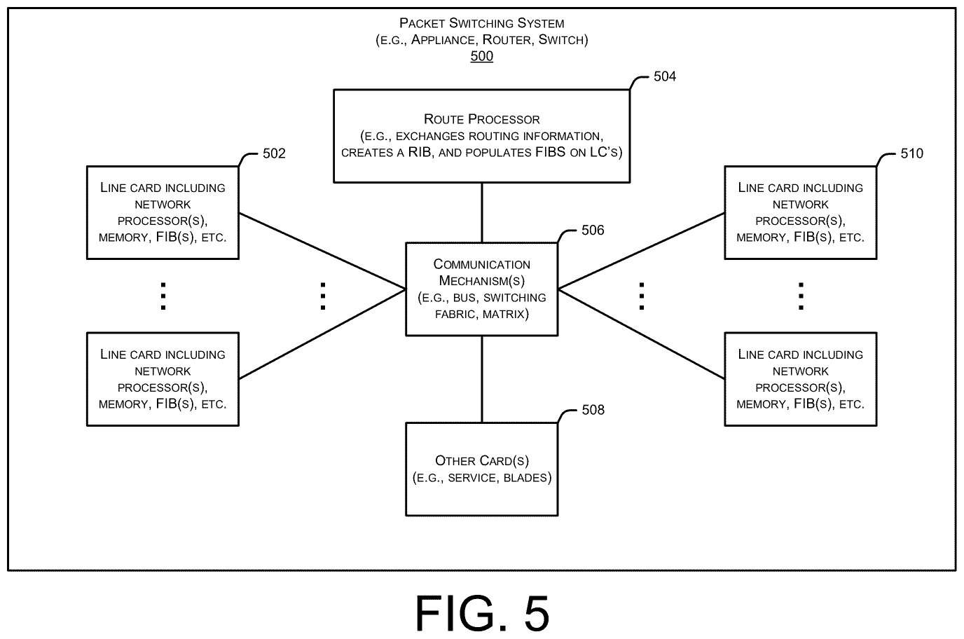

FIG. 5 illustrates a block diagram illustrating an example packet switching device (or system) 500 that can be utilized to implement various aspects of the technologies disclosed herein. In some examples, packet switching device(s) 500 may be employed in various networks, such as, for example, service border device 106 and edge device 108 described with respect to FIG. 1.

In some examples, a packet switching device 500 may comprise multiple line card(s) 502, 510, each with one or more network interfaces for sending and receiving packets over communications links (e.g., possibly part of a link aggregation group). The packet switching device 500 may also have a control plane with one or more processing elements for managing the control plane and/or control plane processing of packets associated with forwarding of packets in a network. The packet switching device 500 may also include other cards 508 (e.g., service cards, blades) which include processing elements that are used to process (e.g., forward/send, drop, manipulate, change, modify, receive, create, duplicate, apply a service) packets associated with forwarding of packets in a network. The packet switching device 500 may comprise hardware-based communication mechanism 506 (e.g., bus, switching fabric, and/or matrix, etc.) for allowing its different entities, line cards 502, 504, 508 and 510 to communicate. Line card(s) 502, 510 may typically perform the actions of being both an ingress and/or an egress line card 502, 510, in regard to multiple other particular packets and/or packet streams being received by, or sent from, packet switching device 500.

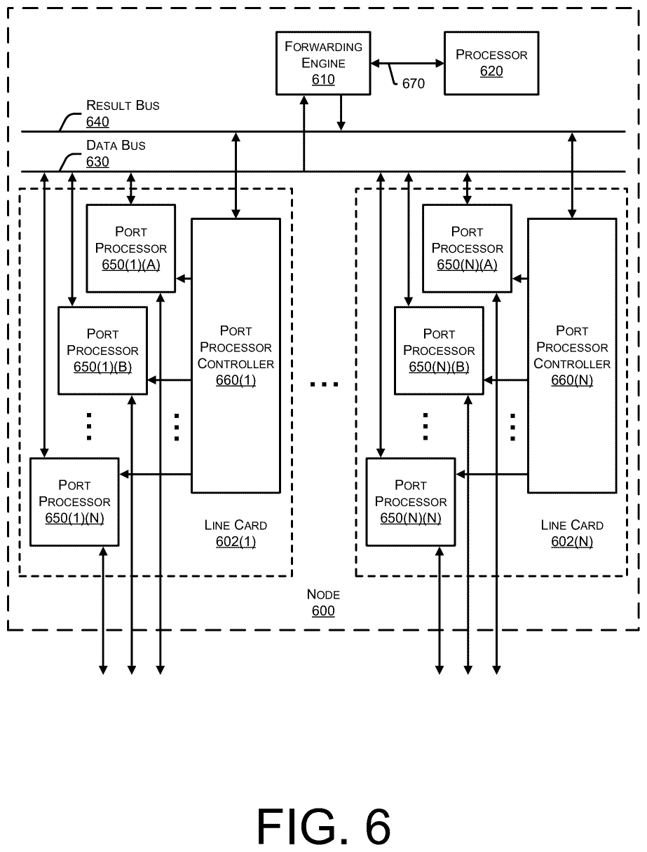

FIG. 6 illustrates a block diagram illustrating certain components of an example node 600 that can be utilized to implement various aspects of the technologies disclosed herein. In some examples, node(s) 600 may be employed in various networks, such as, for example, enterprise network 102 and data center fabric 116 as described with respect to FIG. 1.

In some examples, node 600 may include any number of line cards 602 (e.g., line cards 602(1)-(N), where N may be any integer greater than 1) that are communicatively coupled to a forwarding engine 610 (also referred to as a packet forwarder) and/or a processor 620 via a data bus 630 and/or a result bus 640. Line cards 602(1)-(N) may include any number of port processors 650(1)(A)-(N)(N) which are controlled by port processor controllers 660(1)-(N), where N may be any integer greater than 1. Additionally, or alternatively, forwarding engine 610 and/or processor 620 are not only coupled to one another via the data bus 630 and the result bus 640, but may also communicatively coupled to one another by a communications link 670.

The processors (e.g., the port processor(s) 650 and/or the port processor controller(s) 660) of each line card 602 may be mounted on a single printed circuit board. When a packet or packet and header are received, the packet or packet and header may be identified and analyzed by node 600 (also referred to herein as a router) in the following manner. Upon receipt, a packet (or some or all of its control information) or packet and header may be sent from one of port processor(s) 650(1)(A)-(N)(N) at which the packet or packet and header was received and to one or more of those devices coupled to the data bus 630 (e.g., others of the port processor(s) 650(1)(A)-(N)(N), the forwarding engine 610 and/or the processor 620). Handling of the packet or packet and header may be determined, for example, by the forwarding engine 610. For example, the forwarding engine 610 may determine that the packet or packet and header should be forwarded to one or more of port processors 650(1)(A)-(N)(N). This may be accomplished by indicating to corresponding one(s) of port processor controllers 660(1)-(N) that the copy of the packet or packet and header held in the given one(s) of port processor(s) 650(1)(A)-(N)(N) should be forwarded to the appropriate one of port processor(s) 650(1)(A)-(N)(N). Additionally, or alternatively, once a packet or packet and header has been identified for processing, the forwarding engine 610, the processor 620, and/or the like may be used to process the packet or packet and header in some manner and/or maty add packet security information in order to secure the packet. On a node 600 sourcing such a packet or packet and header, this processing may include, for example, encryption of some or all of the packets or packet and header's information, the addition of a digital signature, and/or some other information and/or processing capable of securing the packet or packet and header. On a node 600 receiving such a processed packet or packet and header, the corresponding process may be performed to recover or validate the packets or packet and header's information that has been secured.

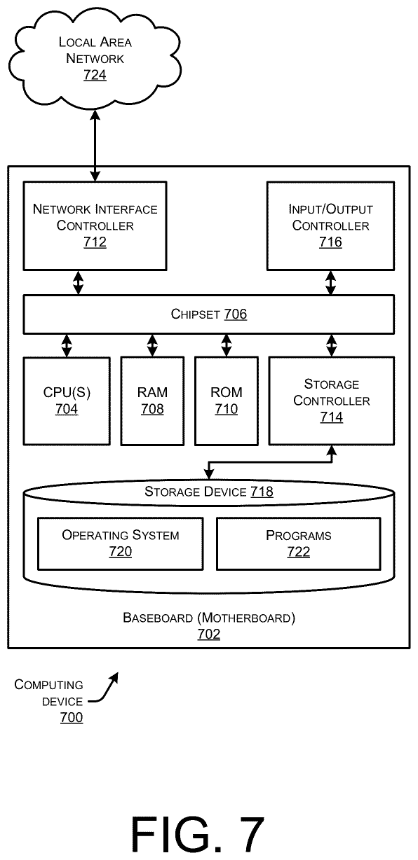

FIG. 7 shows an example computer architecture for a computing device (or network routing device) 700 capable of executing program components for implementing the functionality described above. The computer architecture shown in FIG. 7 illustrates a conventional server computer, workstation, desktop computer, laptop, tablet, network appliance, e-reader, smartphone, or other computing device, and can be utilized to execute any of the software components presented herein. The computing device 700 may, in some examples, correspond to network controller 104, service border device 106, edge device 108, authentication server 112, the packet switching system 500, and/or the node 600 described herein with respect to FIGS. 1, 2, 5, and 6, respectively.

The computing device 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computing device 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computing device 700. The chipset 706 can further provide an interface to a computer-readable storage medium such as a read-only memory (“ROM”) 710 or non-volatile RAM (“NVRAM”) for storing basic routines that help to start up the computing device 700 and to transfer information between the various components and devices. The ROM 710 or NVRAM can also store other software components necessary for the operation of the computing device 700 in accordance with the configurations described herein.

The computing device 700 can operate in a networked environment using logical connections to remote computing devices and computer systems through a network, such as the network 724. The chipset 706 can include functionality for providing network connectivity through a NIC 712, such as a gigabit Ethernet adapter. The NIC 712 is capable of connecting the computing device 700 to other computing devices over the network 724. It should be appreciated that multiple NICs 712 can be present in the computing device 700, connecting the computer to other types of networks and remote computer systems.

The computing device 700 can be connected to a storage device 718 that provides non-volatile storage for the computing device 700. The storage device 718 can store an operating system 720, programs 722, and data, which have been described in greater detail herein. The storage device 718 can be connected to the computing device 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computing device 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 can further read information from the storage device 718 by detecting the physical states or characteristics of one or more particular locations within the physical storage units.

In addition to the mass storage device 718 described above, the computing device 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 700. In some examples, the operations performed by the network controller 104, service border device 106, edge devices 108, authentication server 112, and or any components included therein, may be supported by one or more devices similar to computing device 700. Stated otherwise, some or all of the operations performed by the network controller 104, service border device 106, edge devices 108, authentication server 112, and or any components included therein, may be performed by one or more computing device 700 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computing device 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computing device 700.

In one embodiment, the storage device 718 or other computer-readable storage media is encoded with computer-executable instructions which, when loaded into the computing device 700, transform the computer from a general-purpose computing system into a special-purpose computer capable of implementing the embodiments described herein. These computer-executable instructions transform the computing device 700 by specifying how the CPUs 704 transition between states, as described above. According to one embodiment, the computing device 700 has access to computer-readable storage media storing computer-executable instructions which, when executed by the computing device 700, perform the various processes described above with regard to FIG. 5 and FIG. 6. The computing device 700 can also include computer-readable storage media having instructions stored thereupon for performing any of the other computer-implemented operations described herein.

The computing device 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the computing device 700 might not include all of the components shown in FIG. 7, can include other components that are not explicitly shown in FIG. 7, or might utilize an architecture completely different than that shown in FIG. 7.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, at a fabric edge device and from a host device, an ingress data packet with the host device as a source and a destination of a data center device;
transmitting, by the fabric edge device and to a host tracking database (DB), a request for a security group associated with the data center device; and
in response to receiving the security group associated with the data center device, applying, by the fabric edge device a security policy associated with the security group to the ingress data packet.

2. The method of claim 1, wherein the host tracking DB receives information associated with the data center device from a service border device, the information including an Internet Protocol (IP) prefix of the data center device and the security group as determined by a security infrastructure.

3. The method of claim 2, wherein the service border device is configured by a Software Defined Network (SDN) controller to learn data center device IP prefixes to security group bindings from the security infrastructure.

4. The method of claim 2, wherein the security infrastructure receives IP prefixes and associated security groups from at least one of a Software Defined Network (SDN) controller, a data center policy engine, or applications.

5. The method of claim 2, wherein the service border device receives IP prefix to security group bindings from the security infrastructure via a security tag exchange protocol (SXP).

6. The method of claim 2, wherein the information associated with the data center device indicates an absence of a preexisting IP prefix to security group binding, and further comprising receiving, at the host tracking DB and from the service border device, an indication that the IP prefix is associated with a reserved unassigned data center security group, and wherein the service border device corresponds to an egress tunnel endpoint.

7. The method of claim 1, wherein the data center device security group is mapped to a data center device IP prefix in a Forwarding Information Base (FIB).

8. A system comprising:
one or more processors; and
one or more computer-readable media storing computer-executable instructions that, when executed by the one or more processors, cause the one or more processors to perform operations comprising:
receiving, at a fabric edge device and from a host device, an ingress data packet with the host device as a source and a destination of a data center device;
transmitting, by the fabric edge device and to a host tracking database (DB), a request for a security group associated with the data center device; and
in response to receiving the security group associated with the data center device, applying, by the fabric edge device a security policy associated with the security group to the ingress data packet.

9. The system of claim 8, wherein the host tracking DB receives information associated with the data center device from a service border device, the information including an Internet Protocol (IP) prefix of the data center device and the security group as determined by a security infrastructure.

10. The system of claim 9, wherein the service border device is configured by a Software Defined Network (SDN) controller to learn data center device IP prefixes to security group bindings from the security infrastructure.

11. The system of claim 9, wherein the security infrastructure receives IP prefixes and associated security groups from at least one of a Software Defined Network (SDN) controller, a data center policy engine, or applications.

12. The system of claim 9, wherein the service border device receives IP prefix to security group bindings from the security infrastructure via a security tag exchange protocol (SXP).

13. The system of claim 9, wherein the information associated with the data center device indicates an absence of a preexisting IP prefix to security group binding, and further comprising receiving, at the host tracking DB and from the service border device, an indication that the IP prefix is associated with a reserved unassigned data center security group, and wherein the service border device corresponds to an egress tunnel endpoint.

14. The system of claim 8, wherein the data center device security group is mapped to a data center device IP prefix in a Forwarding Information Base (FIB).

15. One or more non-transitory computer-readable media storing instructions that, when executed, cause one or more processors to perform operations comprising:
receiving, at a fabric edge device and from a host device, an ingress data packet with the host device as a source and a destination of a data center device;
transmitting, by the fabric edge device and to a host tracking database (DB), a request for a security group associated with the data center device; and
in response to receiving the security group associated with the data center device, applying, by the fabric edge device a security policy associated with the security group to the ingress data packet.

16. The one or more non-transitory computer-readable media of claim 15, wherein the host tracking DB receives information associated with the data center device from a service border device, the information including an Internet Protocol (IP) prefix of the data center device and the security group as determined by a security infrastructure.

17. The one or more non-transitory computer-readable media of claim 16, wherein the service border device is configured by a Software Defined Network (SDN) controller to learn data center device IP prefixes to security group bindings from the security infrastructure.

18. The one or more non-transitory computer-readable media of claim 16, wherein the security infrastructure receives IP prefixes and associated security groups from at least one of a Software Defined Network (SDN) controller, a data center policy engine, or applications.

19. The one or more non-transitory computer-readable media of claim 16, wherein the service border device receives IP prefix to security group bindings from the security infrastructure via a security tag exchange protocol (SXP).

20. The one or more non-transitory computer-readable media of claim 16, wherein the information associated with the data center device indicates an absence of a preexisting IP prefix to security group binding, and further comprising receiving, at the host tracking DB and from the service border device, an indication that the IP prefix is associated with a reserved unassigned data center security group, and wherein the service border device corresponds to an egress tunnel endpoint.
